(19) United States
(12) Patent Application Publication
(10) Pub. No.: US 2010/0261844 A1
(43) Pub. Date: Oct. 14, 2010

(54) Thermoplastic Resin Composition and Molded Product Made Therefrom

(75) Inventors: Byung-Choon LEE, Anyang-si (KR); Tae-Uk KIM, Suwon-si (KR); Jin-Kyung CHO, Uiwang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/824,700

(22) Filed: Jun. 28, 2010

Related U.S. Application Data
(63) Continuation-in-part of application No. PCT/KR2008/007892, filed on Dec. 31, 2008.

(30) Foreign Application Priority Data
Dec. 31, 2007 (KR) 10-2007-0141912

(51) Int. Cl. C08L 51/04

(52) U.S. Cl. 525/67; 525/63

(57) ABSTRACT

A thermoplastic resin composition includes a polycarbonate resin, a low molecular weight polymethyl(meth)acrylate resin, and a core-shell graft copolymer, and the low molecular weight polymethyl(meth)acrylate resin has a weight average molecular weight ranging from 5000 to 30,000. The thermoplastic resin composition can have excellent scratch resistance, impact resistance, and transparency, and accordingly can be used in various molded products such as external parts of electronics, external materials of a car, and the like, which can simultaneously require scratch and impact resistance and transparency.

### CROSS-REFERENCE TO RELATED APPLICATIONS

This application is a continuation-in-part of International Application No. PCT/KR2008/007892, filed Dec. 31, 2008, pending, which designates the U.S., published as WO 2009/091155, and is incorporated herein by reference in its entirety, and claims priority therefrom under 35 USC Section 120. This application also claims priority under 35 USC Section 119 from Korean Patent Application No. 10-2007-0141912, filed Dec. 31, 2007, in the Korean Intellectual Property Office, the entire disclosure of which is also incorporated herein by reference.

### FIELD OF THE INVENTION

The present invention relates to a thermoplastic resin composition and a molded product made therefrom.

### BACKGROUND OF THE INVENTION

Polycarbonate resins have excellent toughness, impact resistance, thermal stability, self-extinguishing properties, dimension stability, and heat resistance, and can thereby be used in the production of electronic products such as mobile phone housings, backlight frames, connectors, and the like. Polycarbonate resins are also used for auto parts such as headlights, instrument panels, and the like, and as an alternative glass material requiring heat resistance and impact resistance.

However, when polycarbonate resins are used in the production of a product requiring heat resistance, it has the disadvantage of relatively deteriorated scratch resistance as compared with glass. It also becomes yellow when it is exposed to sunlight for a long time.

Accordingly, there has been much research on improving the scratch resistance of polycarbonate.

For example, U.S. Pat. Nos. 3,410,838 and 4,027,073 disclose a surface treatment method using a Si compound and an acryl-based UV coating method to improve the scratch characteristics. In addition, various patents propose using alkylmethacrylate, such as U.S. Pat. No. 5,338,798 (a method of using syndiotactic polymethyl(meth)acrylate), U.S. Pat. No. 5,292,809 (a method of using a blend of polycarbonate containing fluorine substituted bisphenol and polymethyl methacrylate), and U.S. Pat. No. 4,743,654 (a single-phase mixture of polycarbonate and polyalkyl methacrylate). However, these compounds are very expensive and can have sharply-deteriorated transparency when used with an alkyl methacrylate within a limited range.

In addition, when a conventional polymethyl(meth)acrylate resin is mixed with polycarbonate, the mixture may not have good transparency due to the refractive index difference and lack of compatibility between the two materials.

### SUMMARY OF THE INVENTION

An exemplary embodiment of the present invention provides a thermoplastic resin composition that can have excellent scratch resistance, transparency, and impact resistance.

Another embodiment of the present invention provides a molded product made from the thermoplastic resin composition.

The embodiments of the present invention are not limited to the above technical purposes, and a person of ordinary skill in the art can understand other technical purposes.

According to one embodiment of the present invention, provided is a thermoplastic resin composition that includes 60 to 96 parts by weight of polycarbonate resin, 1 to 30 parts by weight of a low molecular weight polymethyl (meth)acrylate resin, and 1 to 20 parts by weight of a core-shell graft copolymer, each based on the total weight of the thermoplastic resin composition.

According to another embodiment of the present invention, provided is a molded product made from the thermoplastic resin composition.

Hereinafter, further embodiments of the present invention will be described in detail.

According to one embodiment of the present invention, a thermoplastic resin composition can have excellent scratch and impact resistance and transparency, and accordingly can be used in various molded products such as external parts of electronics, exterior materials for a car, and the like that simultaneously require scratch and impact resistance and transparency.

### DETAILED DESCRIPTION OF THE INVENTION

The present invention now will be described more fully hereinafter in the following detailed description of the invention and with reference to the accompanying drawings, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

One embodiment of the present invention provides a thermoplastic resin composition that includes 60 to 96 parts by weight of polycarbonate resin, 1 to 30 parts by weight of a low molecular weight polymethyl(meth)acrylate resin, and 1 to 20 parts by weight of a core-shell graft copolymer, each based on the total weight of the thermoplastic resin composition.

When the thermoplastic resin composition includes each component in an amount within the above ranges, the thermoplastic resin can have transparency and impact resistance. When the thermoplastic resin composition includes a low molecular weight polymethyl(meth)acrylate resin and a conventional polymethyl(meth)acrylate resin in the same amount, it can have excellent scratch resistance and improved transparency. In addition, when it includes a core-shell graft copolymer with an improved refractive index, it can simultaneously have excellent impact resistance and transparency.

As used herein, when a specific definition is not otherwise provided, the term “an alkyl” refers to a C1 to C20 alkyl, and the term “an aryl” refers to a C6 to C30 aryl.

Exemplary components included in the thermoplastic resin composition according to embodiments of the present invention will hereinafter be described in detail.

(A) Polycarbonate Resin

The polycarbonate resin may be prepared by reacting one or more diphenols of the following Formula 1 with a compound of phosgene, halogen formate, carbonate, or combinations thereof.

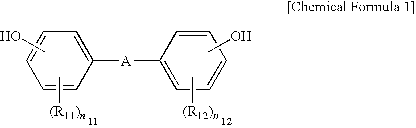

In the above Formula 1,

A is a single bond, substituted or unsubstituted C1 to C5 alkylene, substituted or unsubstituted C1 to C5 alkylidene, substituted or unsubstituted C3 to C6 cycloalkylene, substituted or unsubstituted C5 to C6 cycloalkylidene, CO, S, or SO₂,

R₁₁ and R₁₂ are each independently substituted or unsubstituted C1 to C30 alkyl or substituted or unsubstituted C6 to C30 aryl, and

n₁₁ and n₁₂ are each independently integers ranging from 0 to 4.

As used herein, when a specific definition is not otherwise provided, the term “substituted” refers to one substituted with at least a substituent comprising halogen, C1 to C30 alkyl, C1 to C30 haloalkyl, C6 to C30 aryl, C1 to C20 alkoxy, or a combination thereof.

The diphenols represented by the above Formula 1 may be used in combination to constitute repeating units of the polycarbonate resin. Exemplary diphenols include without limitation hydroquinone, resorcinol, 4,4′-dihydroxydiphenyl, 2,2-bis-(4-hydroxyphenyl)-propane, 2,4-bis-(4-hydroxyphenyl)-2-methylbutane, 1,1-bis-(4-hydroxyphenyl)-cyclohexane, 2,2-bis-(3-chloro-4-hydroxyphenyl)-propane, 2,2-bis-(3,5-dichloro-4-hydroxyphenyl)-propane, and the like.

In an exemplary embodiment, 2,2-bis-(4-hydroxyphenyl)-propane, 2,2-bis-(3,5-dichloro-4-hydroxyphenyl)-propane, or 1,1-bis-(4-hydroxyphenyl)-cyclohexane may be used, and in another exemplary embodiment, 2,2-bis-(4-hydroxyphenyl)-propane (referred to as “bisphenol-A”) may be used.

In an exemplary embodiment, the polycarbonate resin can have a weight average molecular weight ranging from 10,000 to 200,000, and in another embodiment, the polycarbonate can have a weight average molecular weight ranging from 15,000 to 80,000, but the present invention is not limited thereto.

The polycarbonate resin may be a mixture of copolymers prepared from two or more different dipenols. Exemplary polycarbonate resins may include without limitation linear polycarbonate resins, branched polycarbonate resins, polyestercarbonate copolymers, and the like, and combinations thereof.

The linear polycarbonate resin may include a bisphenol-A based polycarbonate resin. The branched polycarbonate resin may include one produced by reacting a multi-functional aromatic compound such as trimellitic anhydride, trimellitic acid, and the like with diphenols and carbonate. The multi-functional aromatic compound may be included in an amount of 0.05 to 2 mol % based on the total weight of the branched polycarbonate resin. The polyester carbonate copolymer resin may be prepared by reacting a difunctional carboxylic acid with diphenols and carbonate. The carbonate may include a diaryl carbonate such as diphenyl carbonate, and ethylene carbonate.

The thermoplastic resin composition may include the polycarbonate resin in an amount of 60 to 96 parts by weight, based on the total weight of the thermoplastic resin composition. In some embodiments, the polycarbonate resin may be used in an amount of 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, or 96 parts by weight. Further, according to some embodiments of the present invention, the amount of the polycarbonate resin can be in a range from any of the foregoing amounts to any other of the foregoing amounts. When the polycarbonate is included in an amount within the above ranges, the thermoplastic resin can have excellent impact resistance.

(B) Low Molecular Weight Polymethyl(Meth)acrylate Resin

The low molecular weight polymethyl(meth)acrylate resin has a weight average molecular weight ranging from 5000 to 30,000. When the low molecular weight polymethyl(meth)acrylate resin has a molecular weight within this range, it can have excellent compatibility with polycarbonate and can thereby improve scratch resistance and transparency of the thermoplastic resin composition.

The low molecular weight polymethyl(meth)acrylate resin has no particular limit, but may include any resin so long as it has a molecular weight within the above range.

The low molecular weight polymethyl(meth)acrylate resin includes 80 to 100 parts by weight of a methyl methacrylate unit and 0 to 20 parts by weight of a vinyl-based monomer that is not methyl methacrylate, based on the total weight of the low molecular weight polymethyl(meth)acrylate resin.

In some embodiments, the low molecular weight polymethyl(meth)acrylate resin includes a methyl methacrylate unit in an amount of 80, 81, 82, 83, 84, 85, 86, 87, 88, 89, 90, 91, 92, 93, 94, 95, 96, 97, 98, 99, or 100 parts by weight. Further, according to some embodiments of the present invention, the amount of the methyl methacrylate unit can be in a range from any of the foregoing amounts to any other of the foregoing amounts.

In some embodiments, the low molecular weight polymethyl(meth)acrylate resin includes the vinyl-based monomer that is not methyl methacrylate in an amount of 0, 1, 2, 3, 4, 5, 6, 7, 8, 9, 10, 11, 12, 13, 14, 15, 16, 17, 18, 19, or 20 parts by weight. Further, according to some embodiments of the present invention, the amount of the vinyl-based monomer that is not methyl methacrylate can be in a range from any of the foregoing amounts to any other of the foregoing amounts.

Exemplary vinyl-based monomers include without limitation alkyl(meth)acrylates that are not methyl methacrylate, styrene, and the like, and combinations thereof.

Non-limiting examples of the vinyl-based monomer include alkenyl aromatic monomers such as styrene, α-methyl styrene, vinyltoluene, vinyl benzyl methyl ether, and the like, unsaturated carbonic acid esters such as methyl acrylate, ethyl acrylate, ethyl methacrylate, butyl acrylate, butyl methacrylate, 2-hydroxy ethyl acrylate, 2-hydroxy ethyl methacrylate, 2-hydroxy butyl acrylate, 2-hydroxy butyl methacrylate, benzyl acrylate, benzyl methacrylate, cyclohexyl acrylate, cyclohexyl methacrylate, phenyl acrylate, phenyl methacrylate, and the like; unsaturated carbonic acid aminoalkyl esters such as 2-amino ethyl acrylate, 2-amino ethyl methacrylate, 2-dimethyl amino ethyl acrylate, 2-dimethyl amino ethyl methacrylate, and the like; carbonic acid vinyl esters such as vinyl acetate, vinyl benzoate, and the like; unsaturated carbonic acid glycidyl esters such as glycidyl acrylate, glycidyl methacrylate, and the like; vinyl cyanide compounds such as acrylonitrile, methacrylonitrile, and the like; unsaturated amides such as acryl amide, methacryl amide, and the like; and combinations thereof.

The thermoplastic resin composition may include the low molecular weight polymethyl(meth)acrylate resin in an amount of 1 to 30 parts by weight, based on the total weight of the thermoplastic resin composition. In another embodiment, the thermoplastic resin composition may include the low molecular weight polymethyl(meth)acrylate resin in an amount of 3 to 20 parts by weight, based on the total weight of the thermoplastic resin composition. In some embodiments, the thermoplastic resin includes the low molecular weight polymethyl(meth)acrylate resin in an amount of 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the low molecular weight polymethyl(meth)acrylate resin can be in a range from any of the foregoing amounts to any other of the foregoing amounts.

When the low molecular weight polymethyl(meth)acrylate resin is included in the thermoplastic resin in an amount within these ranges, the thermoplastic resin composition can have excellent scratch resistance and impact resistance.

(C) Core-Shell Graft Copolymer

The core-shell graft copolymer (C) has a core-shell structure in which an unsaturated monomer is grafted into the core of a rubber to form a hard shell, and plays a role of an impact-reinforcing agent in the resin composition.

The rubber may be obtained from polymerization of at least one rubber monomer comprising a C4 to C6 diene-based rubber, an acrylate-based rubber, a silicone-based rubber, or a combination thereof.

Exemplary acrylate-based rubbers include without limitation acrylate monomers such as methylacrylate, ethylacrylate, n-propylacrylate, n-butylacrylate, 2-ethylhexylacrylate, hexylmethacrylate, 2-ethylhexyl(meth)acrylate, and the like, and combinations thereof. Curing agents such as ethyleneglycoldi(meth)acrylate, propyleneglycoldi(meth)acrylate, 1,3-butyleneglycoldi(meth)acrylate, 1,4-butyleneglycoldi(meth)acrylate, allyl(meth)acrylate, triallylcyanurate, and the like, and combinations thereof may be used along with the acrylate monomers.

Exemplary silicone-based rubbers can be obtained from cyclosiloxane. Examples of the cyclosiloxane include without limitation hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, octaphenylcyclotetrasiloxane, and the like, and combinations thereof. These cyclosiloxanes may be used for preparation of the silicone-based rubber. Curing agents such as trimethoxymethyl silane, triethoxyphenyl silane, tetramethoxy silane, tetraethoxy silane, and the like, and combinations thereof may be used along with the cyclosiloxanes.

In one embodiment, the silicone-based rubber or a mixture of the silicone-based rubber and acrylate-based rubber may be used to provide structural stability to the silicone-based rubber.

The rubber can have an average particle diameter ranging from 0.4 to 1 μm, and can be selected based for example on the desired balance of impact resistance and coloring properties.

The core-shell graft copolymer includes the rubber core structure in an amount of 30 to 70 parts by weight and the shell structure in an amount of 70 to 30 parts by weight, each based on 100 parts by weight of the entire core-shell graft copolymer. In some embodiments, the core-shell graft copolymer includes the core structure in an amount of 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 parts by weight, and the shell structure in an amount of 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, or 30 parts by weight, based on the total weight of the core-shell graft copolymer. Further, according to some embodiments of the present invention, the amount of the core structure and the shell structure can be in a range from any of the foregoing amounts to any other of the foregoing amounts. The core-shell graft copolymer including the core and shell structures in an amount within the aforementioned ranges can have excellent compatibility with a thermoplastic resin composition, and can therefore have excellent impact-reinforcing effects.

Exemplary unsaturated monomers that can be grafted into the rubber may include without limitation alkenyl aromatic monomers, C₁-C₈ alkyl(meth)acrylic acid alkyl esters, C₁-C₈ alkyl methacrylic acid esters, anhydrides, C₁-C₈ alkyl- or phenyl N-substituted maleimides, vinyl cyanide compounds, and the like, and combinations thereof.

Non-limiting examples of the alkenyl aromatic monomers include styrene, α-methyl styrene, vinyltoluene, vinyl benzyl methyl ether, and the like, and combinations thereof.

The methacrylic acid alkyl esters and acrylic acid alkyl esters are esters obtained from the reaction of acrylic acid or methacrylic acid, and C1 to C8 monohydroxy alcohols. Specific examples include without limitation methacrylic acid methyl ester, methacrylic acid ethyl ester, methacrylic acid propyl ester, and the like, and combinations thereof. In one embodiment, methacrylic acid methyl ester is used.

The anhydrides include acid anhydrides. For example, the anhydride may be a carboxylic acid anhydride such as maleic anhydride, itaconic anhydride, and the like, and combinations thereof.

Non-limiting examples of the vinyl cyanide compounds include acrylonitrile, methacrylonitrile, and the like, and combinations thereof.

The core-shell graft copolymer can include the graftable unsaturated monomer in an amount of 40 parts by weight. In another embodiment, the core-shell graft copolymer can include the graftable unsaturated monomer in an amount of 5 to 30 parts by weight. In some embodiments, the core-shell graft copolymer includes the graftable unsaturated monomer in an amount of 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 parts by weight. Further, according to some embodiments of the present invention, the amount of the graftable unsaturated monomer can be in a range from any of the foregoing amounts to any other of the foregoing amounts.

When the core-shell graft copolymer includes the graftable monomer in an amount within these ranges, the core-shell graft copolymer can have excellent compatibility with a resin, and thereby can have excellent impact-reinforcing effects.

The thermoplastic resin composition may include the core-shell graft copolymer (C) in an amount of 1 to 20 parts by weight, based on the total weight of the thermoplastic resin composition. In some embodiments, the thermoplastic resin includes the core-shell graft copolymer in an amount of 1, 2, 3, 4, 5, 6, 7, 8, 9, 10, 11, 12, 13, 14, 15, 16, 17, 18, 19, or 20 parts by weight, based on the total weight of the thermoplastic resin composition. Further, according to some embodiments of the present invention, the amount of the core-shell graft copolymer can be in a range from any of the foregoing amounts to any other of the foregoing amounts. When the core-shell graft copolymer is included in an amount within these ranges, it can provide impact-reinforcing effects and also improve mechanical strength of the thermoplastic resin composition such as tensile strength, flexural strength, flexural modulus, and the like.

(D) Other Additives

The thermoplastic resin composition may include one or more additives, such as but not limited to a flame retardant, a lubricant, an antimicrobial agent, a releasing agent, a nuclear agent, a plasticizer, a thermal stabilizer, an antioxidant, a light stabilizer, a commercial compatibilizer, a pigment, dye, an inorganic material additive, and the like, and combinations thereof. The additive(s) can be selected depending on its use and can be used in conventional amounts as known in the art.

The thermoplastic resin composition can be prepared using any conventional technique known in the art for preparing a resin composition. For example, the components and optionally other additives can be mixed and melt extruded into pellet form.

The thermoplastic resin composition can be used for molding various products, and particularly various molded products requiring excellent scratch resistance, impact resistance, and transparency, for example external parts of electronics such as TVs, computers, mobile phones, and devices for office automation, exterior materials for a car, and the like.

Hereinafter, the present invention is illustrated in more detail with reference to examples. However, they are exemplary embodiments of the present invention and are not limiting.

A person having ordinary skills in this art can sufficiently understand parts of the present invention that are not specifically described.

### Preparation of Thermoplastic Resin Composition

### Example 1

A polycarbonate resin, a polymethyl(meth)acrylate resin with a low molecular weight, a polymethyl(meth)acrylate resin, and a core-shell graft copolymer resin used in Example 1 are as follows.

(A) Polycarbonate Resin

A bisphenol-A linear polycarbonate with a weight average molecular weight of 25,000 available as PANLITE L-1250WP from Japanese Teijin Pharma Ltd. is used.

(B) Polymethyl(Meth)Acrylate Resin with a Low Molecular Weight

Methyl methacrylate (MMA), which is an acrylic-based resin, is polymerized to prepare a polymethyl methacrylate resin with a low molecular weight. Methods for polymerizing methyl methacrylate into a polymethyl methacrylate resin with a low molecular weight are well-known to those with ordinary skill in the art, and any conventional polymerization method, such as but not limited to bulk polymerization, solution polymerization, suspension polymerization and emulsion polymerization, may be used to prepare the polymethyl(meth)acrylate resin with a low molecular weight.

The polymethyl methacrylate resin with a low molecular weight has a weight average molecular weight of 5000.

(C) Core-Shell Graft Copolymer

Metablen C-223A made by Japanese Mitsubishi Rayon Co., Ltd. is prepared by graft-polymerizing styrene and an acrylonitrile monomer into a silicon polymer/acrylic-based rubber composite.

Each of aforementioned components are mixed according to the composition ratios in the following Table 1 and prepared into pellet form by using a twin screw extruder of Φ=45 mm. The pellets are dried at 90° C. for 3 hours or more and then injection molded using a 10 oz injection molding machine at a plastic shaping temperature ranging from 220 to 280° C. and a molding temperature ranging from 60 to 100° C. to fabricate a flat specimen.

### Examples 2 to 3

A specimen is fabricated using the same method as Example 1, except for mixing the components of the thermoplastic resin composition according to composition ratios provided in the following Table 1.

### Comparative Examples 1 to 4

A specimen is fabricated using the same method as Example 1, except that a polymethyl methacrylate resin with a weight average molecular weight of 95,000 available as L-84 from Madison Research Corp (MRC) is used instead of polymethyl methacrylate resin with a low molecular weight, and then the components of the thermoplastic resin composition according to composition ratios provided in the following Table 1 are mixed.

TABLE 1

| | | | | Comparative | | | |
|---|---|---|---|---|---|---|---|
| | Example | | | Example | | | |
| | 1 | 2 | 3 | 1 | 2 | 3 | 4 |
| Polycarbonate resin | 92 | 90 | 85 | 85 | 90 | 40 | 100 |
| (parts by weight) | | | | | | | |
| Low molecular weight polymethyl | 3 | 5 | 10 | — | — | 50 | — |
| (meth)acrylate resin | | | | | | | |
| (parts by weight) | | | | | | | |
| Core-shell graft copolymer | 5 | 5 | 5 | 5 | — | 10 | — |
| (parts by weight) | | | | | | | |
| Polymethyl (meth)acrylate resin | — | — | — | 10 | — | — | — |
| (parts by weight) | | | | | | | |

Properties of the Thermoplastic Resin Compositions

The properties of the specimens of Examples 1 to 3 and Comparative Examples 1 to 4 are evaluated using the following methods. The results are provided in the following Table 2.

(1) Scratch resistance: a contact surface profile analyzing device (Ambios Technology, Inc., XP-1) is used to measure widths of scratches by using a 0.7 mm ball-shaped tungsten carbide stylus at a of load 1 kg and a speed of 75 mm/min.

(2) Impact resistance: a notch is made in ⅛″ izod specimens to evaluate impact resistance according to ASTM D256 evaluation method.

(3) Transparency: the transparency of the specimens is evaluated using Color-Eye 7000A equipment made by Gretag MacBeth.

TABLE 2

| | Example | | | Comparative Example | | | |
|---|---|---|---|---|---|---|---|
| | 1 | 2 | 3 | 1 | 2 | 3 | 4 |
| Scratch width (μm) | 300 | 290 | 280 | 292 | 290 | 230 | 315 |
| Transparence (%) | 90 | 88 | 81 | 64 | 66 | 5 | 96 |
| Impact resistance IZ | 68 | 66 | 63 | 58 | 42 | 8 | 60 |
| (⅛″, kgf · cm/cm) | | | | | | | |

Referring to Table 2, the specimens including a polymethyl(meth)acrylate resin with a low molecular weight and a core-shell graft copolymer with a polycarbonate resin in a predetermined ratio according to Examples 1 to 3 have excellent scratch resistance, transparency, and impact resistance characteristics compared with the ones including common polymethyl(meth)acrylate according to Comparative Examples 1 to 4.

In addition, when the specimens include polymethylacrylate resin with a low molecular weight in an amount greater than the compositions of the invention as shown in Comparative Example 3, they have deteriorated transparency and impact resistance.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A thermoplastic resin composition comprising:
60 to 96 parts by weight of a polycarbonate resin;
1 to 30 parts by weight of a low molecular weight polymethyl(meth)acrylate resin; and
1 to 20 parts by weight of a core-shell graft copolymer.

2. The thermoplastic resin composition of claim 1, wherein the low molecular weight polymethyl(meth)acrylate resin has a weight average molecular weight ranging from 5000 to 30,000.

3. The thermoplastic resin composition of claim 1, wherein the polycarbonate resin comprises a linear polycarbonate, a branched polycarbonate, or a polyester carbonate copolymer.

4. The thermoplastic resin composition of claim 1, wherein the low molecular weight polymethyl(meth)acrylate resin comprises 80 to 100 parts by weight of a methyl methacrylate unit and 0 to 20 parts by weight of a vinyl-based monomer that is not methyl methacrylate.

5. The thermoplastic resin composition of claim 4, wherein the low molecular weight polymethyl(meth)acrylate resin comprises 100 parts by weight of a methyl methacrylate unit.

6. The thermoplastic resin composition of claim 1, wherein the core-shell graft copolymer has a core-shell structure wherein an unsaturated monomer is grafted to a rubber polymer.

7. The thermoplastic resin composition of claim 6, wherein the rubber polymer is formed by polymerizing a C4 to C6 diene-based rubber monomer, an acrylate-based rubber monomer, a silicone-based rubber monomer, or a combination thereof, and wherein the unsaturated monomer comprises an alkenyl aromatic monomer, (meth)acrylic acid alkyl ester, anhydride, alkyl- or phenyl N-substituted maleimide, vinyl cyanide compound or a combination thereof.

8. The thermoplastic resin composition of claim 6, wherein the core-shell graft copolymer comprises a silicon polymer/acrylic-based rubber composite core and a styrene/acrylonitrile shell.

9. A molded product made using the thermoplastic resin composition according to claim 1.
